(19) United States
(12) Patent Application Publication
(10) Pub. No.: US 2025/0277343 A1
(43) Pub. Date: Sep. 4, 2025

(54) INDUSTRIAL PLANT FOR MAKING BITUMINOUS MACADAMS

(71) Applicant: MARINI S.P.A., Alfonsine (Ravenna) (IT)

(72) Inventor: Andrea PIRAZZINI, Cotignola (Ravenna) (IT)

(21) Appl. No.: 19/055,187

(22) Filed: Feb. 17, 2025

(30) Foreign Application Priority Data
Mar. 1, 2024 (IT) 102024000004660

(51) Int. Cl. E01C 19/10; E01C 19/05; E01C 19/08; F26B 11/02; F26B 23/02

(52) U.S. Cl. CPC E01C 19/1004; E01C 19/05; E01C 19/08; E01C 19/1072; E01C 19/1077; F26B 11/026; F26B 23/02

(57) ABSTRACT

Described is an industrial plant for the production of bituminous macadams including: a dryer equipped with a loading head for introducing into the drying drum a virgin inert lithic material, an unloading head, a supplying device for introducing into the drying drum a recycled bituminous material, a burner, a system for supplying the inert virgin inert lithic material and the recycled bituminous material according to a first feed direction; the industrial plant includes a mixer downstream of the dryer, a first supply line between the unloading head and the mixer, a second supply line between the unloading head and the mixer, a diverter between the unloading head and said first and second supply lines adjustable between a first operating configuration wherein the unloading head is in communication with the first supply line and a second operating configuration wherein the unloading head is in communication with the second supply line.

This application claims priority to Italian Patent Application 102024000004660 filed Mar. 1, 2024, the entirety of which is incorporated by reference herein.

This invention relates to an industrial plant and in particular an industrial plant for the production of mixtures in the form of macadams with bituminous and non-bituminous binders, briefly also bituminous macadams intended in particular for making road surfaces.

In the sector of industrial plants for the production of bituminous macadams there are widespread plants which allow the use, in the mixtures, of virgin inert lithic materials, such as, for example, gravel, hereinafter also simply referred to as virgin material, and recycled or regenerated material (Recycled Asphalt Pavement RAP) derived, for example, from milling existing road pavements.

Both virgin materials and recycled materials must be in predetermined physical conditions in order to be mixed (for example, with high temperature and dried), so they are also processed thermodynamically in the plants of interest.

For example, the patent document EP3551801, in the name of the same Applicant as this invention, illustrates a plant for the production and distribution of bituminous macadams comprising a counter-current drier equipped with a single burner for the drying of the materials to be processed.

The drier consists, schematically, of a first and a second drum, positioned one after the other, wherein in the first drum, closest to the burner, virgin materials are dried whilst in the second drum the materials are dried containing bitumen, bituminous macadams or bituminous recycled material or mixed materials which contain at least a part of materials containing bitumen.

The drier therefore has a first outlet, in the first drum, for the dried virgin materials and a second outlet, in the second drum, for the dried recycled materials.

The dryer is located above the mixer normally provided for reducing as much as possible obstructions due to the heated and sticky recycled material downstream of the dryer.

The plant described in patent document EP3551801 is very complex and relatively expensive and, in general, the plants for making bituminous macadams are affected by clogging problems due to the heated bituminous material.

The need is felt in the trade for plants for making bituminous macadams which are relatively simple, which can also process large quantities of recycled material but in which the possibility of blockages due to the latter once heated is reduced.

In this context, the aim is to propose a plant for the production of bituminous macadams that is capable of overcoming at least some of the drawbacks of the prior art and of meeting the above mentioned need.

In particular, the aim of this invention is to provide a plant for the production of bituminous macadams which is simple and allows an increase in the percentage of recycled material in the macadams containing the possible obstructions due to the heated recycled material.

This aim is achieved by a plant for the production of bituminous macadams comprising the technical features described in one or more of the accompanying claims. The dependent claims correspond to possible different embodiments of the invention.

According to a first aspect, this invention relates to a plant for the production of bituminous macadams.

The industrial plant for the production of bituminous macadams, described only insofar as necessary for understanding this invention, comprises a drier.

The drier may be, for example, of the type described in EP3221517, to which reference should be made for further details.

Schematically, the drier comprises a drying drum rotating about its own main axis of extension, a loading head at a first end of the drying drum for introducing into the drying drum a virgin inert lithic material, an unloading head at a second end of the drying drum, a supplying device between the loading head and the unloading head for introducing into the drying drum a recycled bituminous material, at least one burner for generating a drying flow in the drying drum and a system for supplying, in a first feed direction, virgin inert lithic material, from the loading head, and recycled bituminous material, from the supplying device, to the unloading head.

The industrial plant comprises a mixer positioned downstream of the dryer according to a second feed direction of a by-product coming from the dryer.

The mixer is positioned lower than the dryer.

The industrial plant, for feeding the by-product coming out from the dryer to the mixer, comprises a first line for feeding by-product between the unloading head of the dryer and the mixer and a second line for feeding by-product between the unloading head of the dryer and the mixer.

As the mixer is lower than the dryer, the first and second feed lines can feed the by-product from the dryer to the mixer using gravity.

The industrial plant comprises a diverter between the unloading head and the first and the second supply lines. The diverter is adjustable between a first operating configuration wherein the unloading head and the dryer are in communication with the first supply line and a second operating configuration wherein the unloading head and the dryer are in communication with the second supply line.

Preferably, the first supply line has a first inlet in communication with the diverter and a first outlet at the mixer.

Preferably, the second supply line has a second inlet in communication with the diverter and a second outlet at the mixer.

The presence of two lines downstream of the dryer to bring the by-product coming out from the dryer to the mixer allows one, for example the first, to be directed to a by-product which does not comprise recycled bituminous material or does not comprise very much and the other, for example the second, to a by-product comprising a large quantity of recycled bituminous material.

For example, the first line may be intended for a by-product comprising recycled bituminous material in a quantity of between 0 and 40% by weight, whilst the second line may be intended for a by-product comprising recycled bituminous material in a quantity of between 0 and 60% by weight. Preferably, the second line is intended for a by-product comprising recycled bituminous material in a quantity of between 40% and 60% by weight.

For simplicity, reference will be made below to a by-product comprising recycled bituminous material in a quantity of <40% such as a by-product with little RAP and to a by-product comprising recycled bituminous material in a quantity of >40% such as a by-product with a large quantity of RAP.

The plant is in this way very simple but versatile; in the case of processing by-products with a high concentration of recycled bituminous material the second supply line to the mixer can be used which can be equipped, also in known manner, for managing bitumen without particular drawbacks leaving the first line completely clear. In the case of processing by-products without or with little recycled bituminous material, the first supply line to the dedicated mixer can be used which can be equipped, also in known manner, for managing even just inert lithic materials.

The plant may also produce bituminous macadam with greater quantities of RAP which may be supplied directly into the mixer from a dedicated line for supplying cold RAP which may be provided in the plant.

Preferably, the first line comprises a sieving unit defining the first inlet.

Advantageously, the sieving unit may be provided in the first line dedicated to the supply of by-products without or with little bituminous material to distinguish the grain size of the by-product.

Preferably, the sieving unit comprises a sieve which, in the particular case in which the by-product does not comprise recycled bituminous material, may select the grain size of the inert lithic material.

The sieving unit may comprise a by-product transit channel or chute and a by-pass system for excluding the sieve.

Advantageously, if the by-product also comprises a minimum part of recycled bituminous material which could clog the sieve, the by-pass system can divert the by-product towards the chute to keep the sieve clear.

If the screening unit does not comprise a by-pass system it is possible to use the second line also for mixes with little RAP or, if necessary, even without RAP.

The first supply line may comprise at least one hopper downstream of the sieving unit in which the by-product coming out from the sieving unit may be transferred.

The first supply line may comprise a first weighing machine defining the first outlet in such a way that, advantageously, the by-product is dosed for the mixer on the basis of the recipe set in the plant.

Preferably, the second supply line comprises at least one heated hopper, downstream of the drier, which may keep a by-product comprising a high quantity of RAP sufficiently hot to reduce the risk of clogging of the second line.

The heated hopper may be of substantially known type used for moving the hot RAP coming out from the dryer.

Preferably, the heated hopper defines the inlet of the second supply line in such a way that the by-product coming out from the dryer enters directly into the second supply line.

The second supply line may comprise a second weighing machine defining the second outlet in such a way that, advantageously, the by-product with a large quantity of RAP is dosed for the mixer on the basis of the recipe set in the plant.

Preferably, the dryer is positioned above the first and second supply lines.

Advantageously, in this way, the RAP and the inert lithic material can be supplied to the dryer at the top cold and the hot by-product at the outlet from the drier transits in the first supply line or in the second supply line by gravity.

In particular, in the case of a by-product with a large quantity of RAP, lifting it hot with the cup conveyors normally used is avoided, thus avoiding blockages.

In practice, the first and second supply lines are divided or extend downstream of the dryer and reach the mixer independently of each other.

Preferably, the mixer can also be supplied, in substantially known manner, with the bitumen and a fine filling material (filler) normally present in bituminous macadams.

The second line is basically dedicated to the storage of by-products with large quantities of RAP.

Further features and advantages of the above-mentioned aspects are more apparent in the non-limiting description which follows of a preferred, non-limiting embodiment of a plant for the production of bituminous macadams.

The description is set out below with reference to the accompanying drawings which are provided solely for purposes of illustration without restricting the scope of the invention and in which:

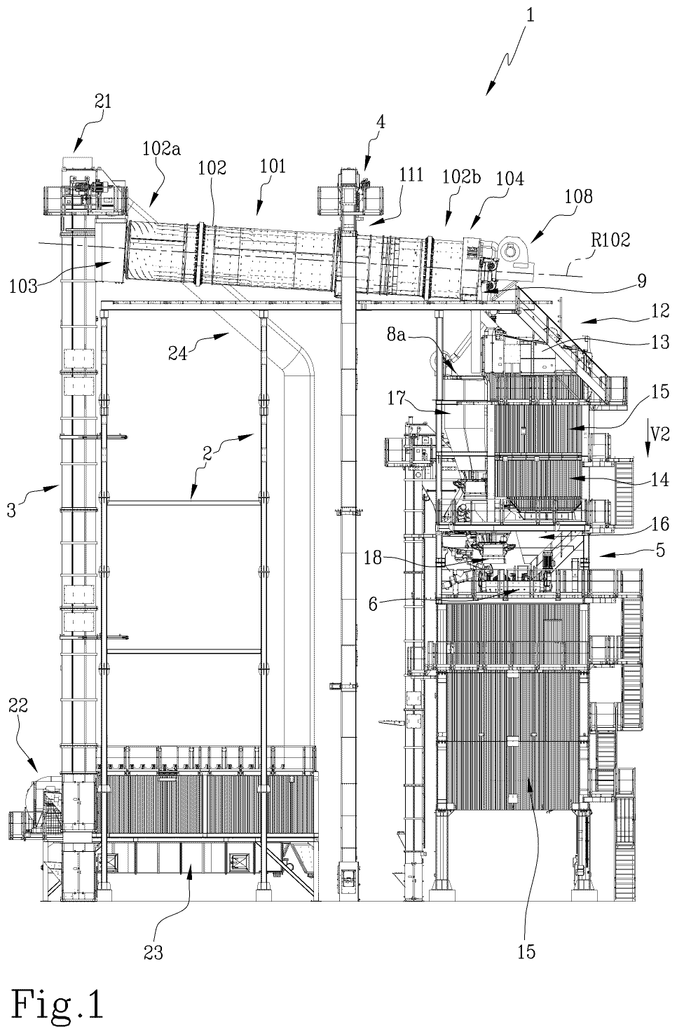

FIG. 1 illustrates a schematic front view of a plant for producing bituminous macadams according to the invention;

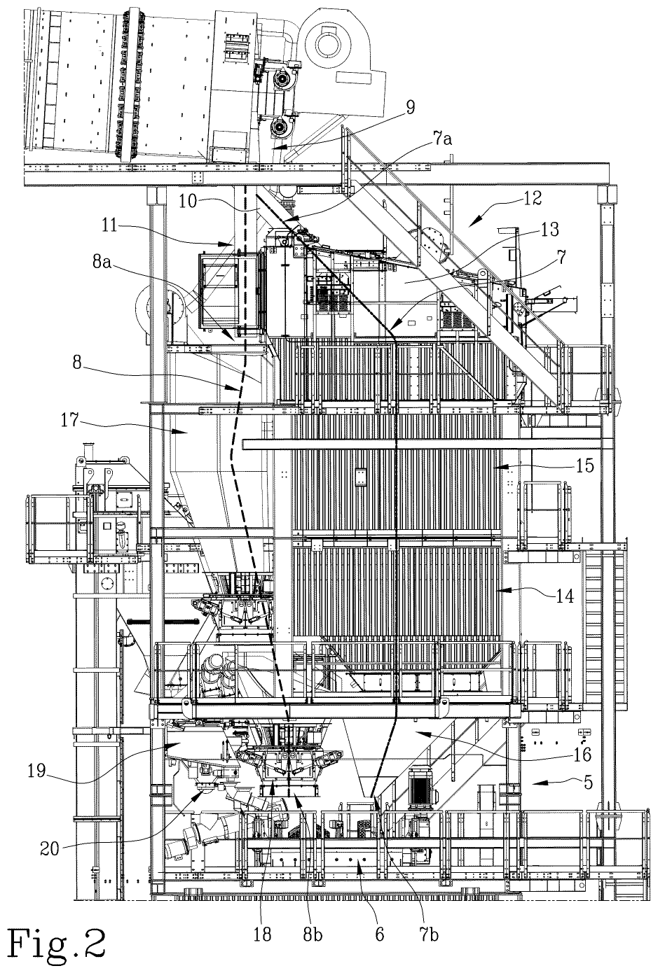

FIG. 2 illustrates a schematic front view of a part of the plant of FIG. 1;

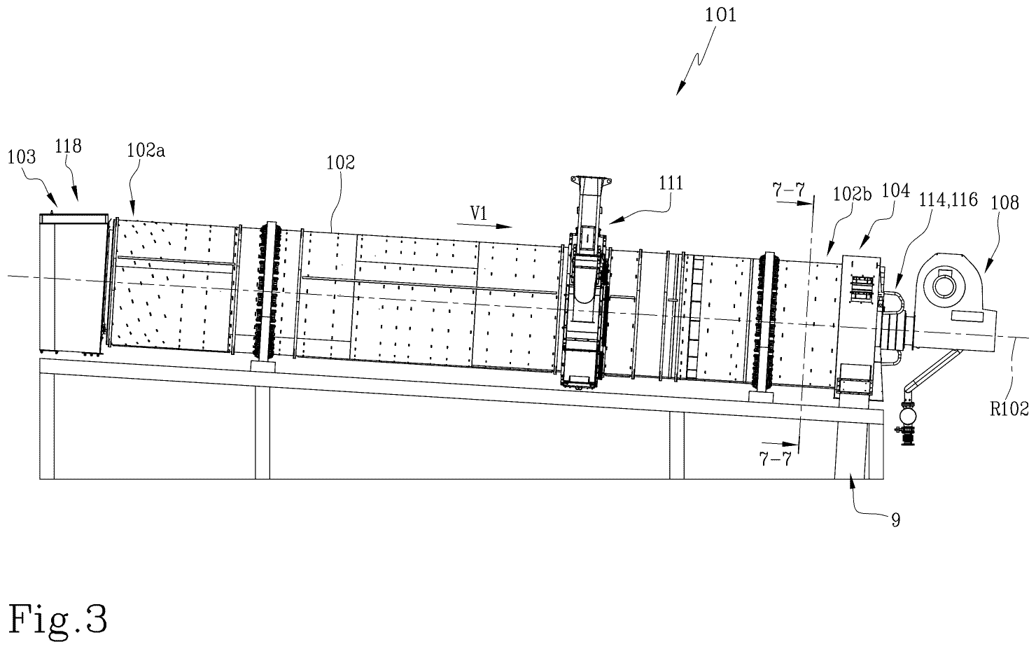

FIG. 3 illustrates a schematic side view of an example of a drier for the plant of FIG. 1;

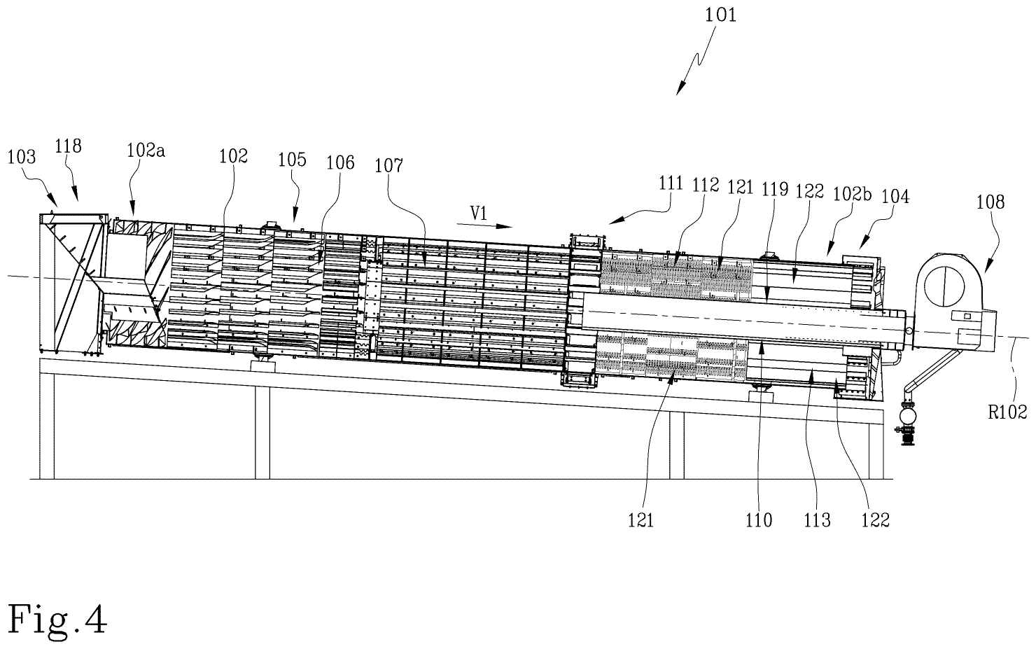

FIG. 4 illustrates a schematic section view, with some parts removed for better clarity, of the drier of FIG. 3;

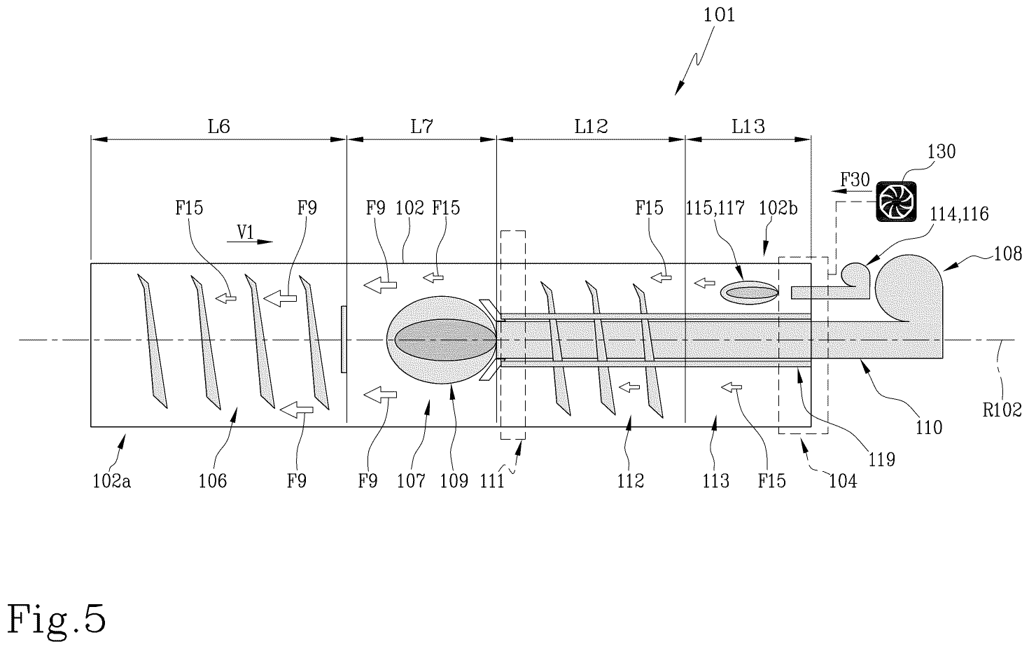

FIG. 5 illustrates a side view, with some parts cut away for better clarity, of the drier of FIGS. 3 and 4;

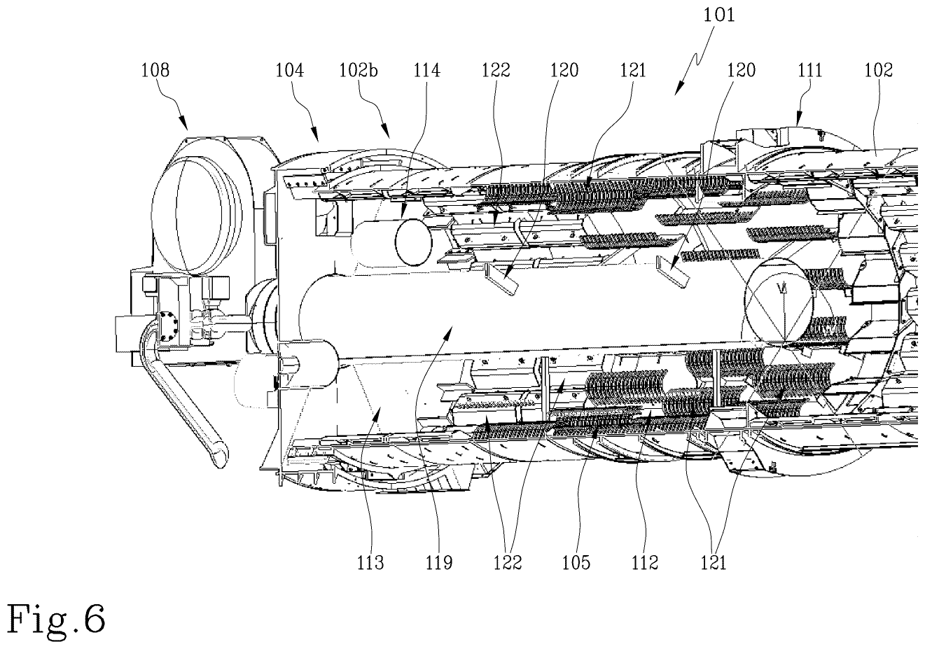

FIG. 6 illustrates a schematic cross section perspective view of a detail of the drier of FIG. 3;

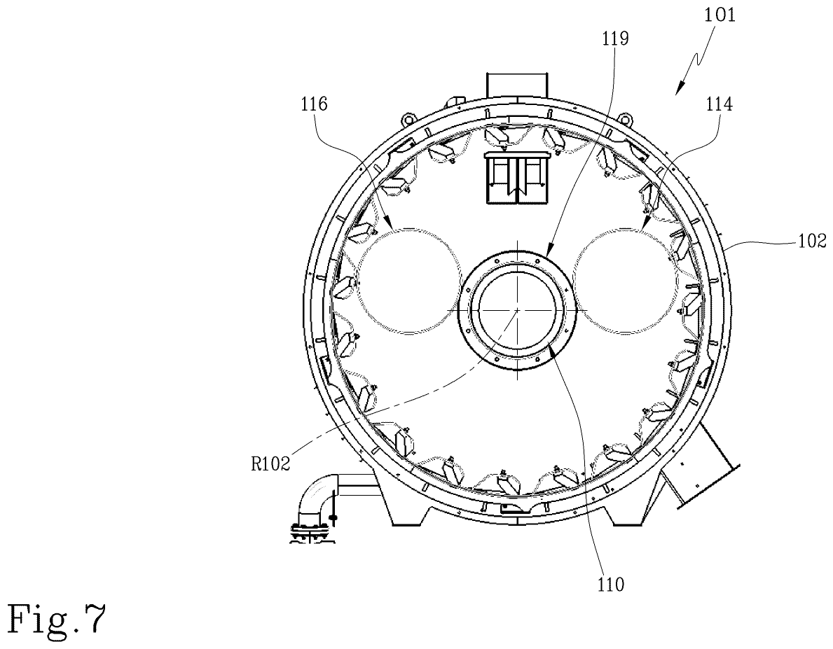

FIG. 7 illustrates a schematic cross section view of the drier of FIG. 3 through the plane 7-7 of FIG. 3;

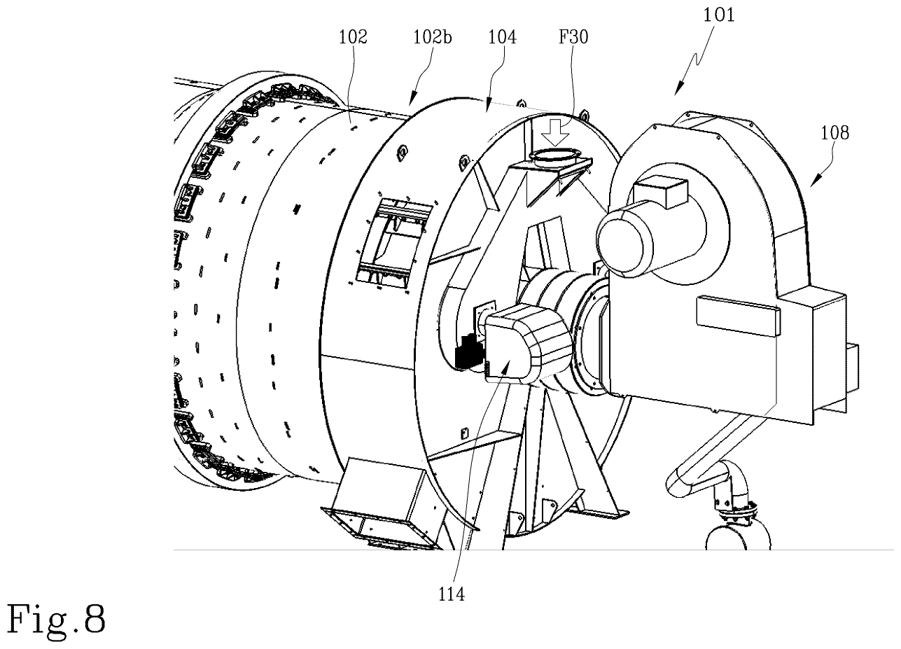

FIG. 8 illustrates a schematic perspective view of a detail of the drier of FIG. 3.

With reference to the accompanying drawings, the numeral 1 denotes in its entirety a plant for producing bituminous macadams.

The plant 1 comprises a drier 101 which may be of substantially known type, such as, for example, that described in patent EP3221517 which is incorporated herein by reference for completeness of description.

The plant 1 comprises a frame 2 for supporting the drier 101.

The drier 101 is located at a height in the plant 1 in such a way that the by-products coming out from the plant can move by gravity.

The drier 101 comprises a drying drum 102 rotating about its own main axis of extension R102.

The drier 101 comprises a loading head 103 at a first end 102a of the drying drum 102, for introducing a virgin inert lithic material into the drying drum 102.

The plant 1 comprises a first elevator 3, of substantially known type, for supplying virgin inert lithic material to the loading head 103.

The drier 101 comprises an unloading head 104 at a second end 102b of the drying drum.

The drier 101 comprises a supplying device 111, positioned between the loading head 103 and the unloading head 104 for introducing a recycled bituminous material into the drying drum 102.

The plant 1 comprises a second elevator 4, of substantially known type, for supplying the recycled bituminous material to the supplying device 111.

The drier 101 comprises one burner 108 for generating a drying flow in the drying drum 102.

The drier comprises a system 105, visible for example in FIG. 4, for feeding the virgin inert lithic material and the recycled bituminous material according to a first feed direction V1 from the loading head 103 and from the supplying device 111 to the unloading head 104.

The feed system 105 is schematically based on the rotation of the drying drum 102, on its inclination, as can be seen in FIGS. 1 and 2 where there is a slope between the loading head 103 and the unloading head 104, and on a particular apparatus provided in the inner surface of the drum 102.

Schematically, the geometry of the equipment, the inclination and the speed of rotation of the drum 102 determine the time of travel of the material from the loading head 103 to the unloading head 104.

The plant 1 comprises a mixing and dosing unit, denoted in its entirety by the numeral 5, for dosing and mixing the ingredients intended to form the bituminous conglomerate.

The mixing and dosing unit 5 is positioned beneath the drier 101 and remains preferably at a height lower than it.

The mixing and dosing unit 5 comprises a mixer 6 which is downstream of the dryer 101 according to a second feed direction V2 of a by-product coming from the dryer 101.

The mixer 6 is positioned, in the plant 1, at a height lower than the dryer 101, in such a way that the by-product coming out from the dryer 101 can be supplied to the mixer 6 by gravity.

The by-product which comes out from the unloading head 104 of the dryer 101 may comprise virgin lithic material and recycled bituminous material in quantities which depend, in substantially known manner, on the recipe of the bituminous conglomerate awaited at the outlet from the production plant and the technical characteristics of the dryer 101 and of the plant 1.

If the by-product comprises both inert lithic material and recycled bituminous material it is also referred to as “mixture”.

The plant 1 comprises a first supply line, positioned between the unloading head 104 of the dryer 101 and the mixer 6 for supplying the by-product to the mixer 6.

The first supply line is denoted in its entirety by the numeral 7 and extends below the dryer 101.

The first supply line 7 is preferably intended for a by-product comprising recycled bituminous material in a quantity of between 0 and 40% by weight.

The first supply line 7 is in practice intended for a by-product consisting only of inert lithic material or a mixture of inert lithic material and RAP wherein the recycled bituminous material is present up to 40% by weight of the mixture.

The plant 1 comprises a second supply line, positioned between the unloading head 104 of the dryer 101 and the mixer 6 for supplying the by-product to the mixer 6.

The second supply line is denoted in its entirety by the numeral 8 and extends below the dryer 101.

The second supply line is intended for a by-product comprising recycled bituminous material in a quantity of between 0 and 60%.

Preferably, the second supply line 8 is intended for a mixture of inert lithic and RAP material wherein the recycled bituminous material is present between 40% and 60% by weight of the mixture.

The plant 1 comprises a diverter 9 between the unloading head 104 and the first and second supply lines 7, 8.

The diverter 9 is configured to direct the by-product coming out from the drier 101 to the first supply line 7 or to the second supply line 8.

The diverter 9 is adjustable between a first operating configuration wherein the unloading head 104, and therefore the dryer 101, are in communication with the first supply line 7 and a second operating configuration wherein the unloading head 104, and therefore the dryer 101, are in communication with the second supply line 8.

For example, the diverter 9 comprises an partition with electro-pneumatic control movable between a first position corresponding to the first operating configuration of the diverter and a second position corresponding to the second operating configuration of the diverter.

The first supply line 7 has an inlet 7a in communication with the diverter 9 and an outlet 7b at the mixer 6.

In particular, the outlet 7b faces the mixer 6.

The second supply line 8 has an inlet 8a in communication with the diverter 6 and an outlet 8b at the mixer 6.

In particular, the outlet 8b faces the mixer 6.

According to the example illustrated, the diverter 9 comprises a first conduit 10 oriented towards the first supply line 7 and a second conduit 11 oriented towards the second supply line 8.

The first conduit 10 may be considered as part of the first supply line 7 and the second conduit 11 may be considered as part of the second supply line 8.

In that case, the inlet of the first conduit 10 may be considered as the inlet 7a of the first supply line 7 and the inlet of the second conduit 11 may be considered as the inlet 8a of the second supply line 8.

According to an alternative embodiment not illustrated, the diverter 9 is integrated in the unloading head 104.

According to the example illustrated, the first supply line 7 comprises a sieving unit, denoted in its entirety by the reference numeral 12, which has the inlet 7a of the first supply line 7.

The sieving unit 12 comprises a sieve 13 for sieving the by-product coming out from the dryer 101.

Usually, a sieve is used when the by-product coming out from the drier consists only of inert lithic material since the presence of any bitumen would occlude, at least partly, the sieve.

The sieving unit 12 comprises a transit channel and a by-pass system, not visible, for excluding the sieve 13 from the first supply line 7 if the by-product also comprises recycled bituminous material.

The first supply line 7 comprises, downstream of the sieving unit 12 in the direction V2, a so-called “under sieve” hopper 14.

According to the example illustrated, the first supply line 7 comprises a supplementary hopper 15, also “under sieve”, positioned between the sieving unit 12 and the hopper 14.

The first supply line 7 comprises a weighing machine 16, downstream of the hoppers 14, 15, for weighing the by-product which transits in the first supply line 7 and dosing it to the mixer 6.

The weighing machine 16 forms part of the mixing and dosing unit 5 and comprises the outlet 7b of the first supply line 7.

The second supply line 8 comprises a heated hopper 17, of substantially known type, downstream of the dryer 101 in the direction V2.

The heated hopper 17 comprises an insulation and a heating system, has geometries without sharp corners and very high descent angles, in the order of, for example 65°-70°, to allow, as mentioned, the passage of a by-product with a large quantity of RAP.

According to the example illustrated, the heated hopper 17 defines the inlet 8a of the second supply line 8.

Downstream of the heated hopper 17 in the direction V2, the second supply line 8 comprises a weighing machine 18 for weighing the by-product which transits in the second supply line 8 and dosing it to the mixer 6.

The weighing machine 18 forms part of the mixing and dosing unit 5 and comprises the outlet 8b of the second supply line 8.

Since the second supply line 8 is intended for the transit of a by-product with a large quantity of RAP, the weighing machine 18 is a weighing machine for conglomerates with a high RAP content with characteristics substantially known in the sector.

For example, the weighing machine 18 comprises an insulation and a heating system, with geometries without sharp corners and very high descent angles, in the order of, for example, 65°-70°.

The plant 1 comprises a system, of substantially known type, for supplying bitumen to the mixer 6.

The mixing and dosing unit 5 comprises a doser 19 for the bitumen forming part of the bitumen supply system.

The plant 1 comprises a system, of substantially known type, for supplying filler to the mixer 6.

The mixing and dosing unit 5 comprises a doser 20 for the filler forming part of the filler supply system.

The diagram of the plant 1 illustrated also shows a flue 21 for evacuating the fumes, a filter 22 and the relative tank 23 under the filter.

A conduit 24 puts the dryer 101 in communication with the filter 22.

The plant comprises a silo or storage system 25 located downstream of the mixing and dosing unit 5 for depositing the bituminous conglomerate obtained in the plant 1.

A preferred embodiment of the drier 101 is described below with particular reference to FIGS. 3 to 8.

The drier 101 described below is advantageously applied in the production plant 1 since it can process a mixture of inert lithic material and recycled bituminous material comprising up to 60% of RAP.

The drying drum 102 comprises a first drying chamber 106 and a first combustion chamber 107 downstream of the first drying chamber 106 according to the feed direction V1.

The drier 101 comprises a first burner 108, of substantially known type, positioned at the second end 102b of the drying drum 102 for generating a first flame 109 in the first combustion chamber 107 and a first drying flow F9 in the first drying chamber 106.

The first burner 108 comprises a feed duct 110 for feeding a fuel to the first flame 109 in the first combustion chamber 107.

Preferably, the first burner 108 has a power of between 9 MW and 30 MW.

The drying drum 102 comprises a second drying chamber 112 downstream of the feed system 111 and upstream of the unloading head 104 according to the feed direction V1.

The drying drum 102 comprises a second combustion chamber 113 downstream of the second drying chamber 112 and upstream of the unloading head 104 according to the feed direction V1.

According to the embodiment illustrated, the total length L6+L7, measured along the axis R102, of the first drying chamber 106 and of the first combustion chamber 107 is equal to 10 m, the second drying chamber 112 has a length L12, measured along the axis R102, of 3.5 m and the second combustion chamber 113 has a length L13, measured along the axis R102, equal to 2 m.

Preferably, the ratio between the total length L6+L7, measured according to the axis R102, of the first drying chamber 106 and of the first combustion chamber 107 and the total length L12+L13 of the second drying chamber 112 and of the second combustion chamber 113 is between 1.5 and 2.5.

Preferably, the ratio between a length L12 of the second drying chamber 112 and the length L13 of the second combustion chamber 113 is between 1 and 4.

The drier 101 comprises at least a second burner 114 having a power less than that of the first burner 108 for generating a second flame 115 in the second combustion chamber 113 and a second flow F15 of combustion gas at least in the second drying chamber 112.

Preferably, the second burner 114 has a power of between 0.5 MW and 4 MW.

According to the embodiment illustrated, the second burner 114 is positioned substantially at the second end 102b of the drying drum 102.

Preferably, the drier comprises a third burner 116 which generates a third flame 117 in the second combustion chamber 113. The second and the third flames 115, 117 combined determine the second flow F15 of combustion gas.

In general, the drier 101 can comprise any number of burners in the second combustion chamber 113 on the basis of the design requirements, in particular as a function of the expected second flow F15 of combustion gas.

Preferably, the third burner 116 has the same power as the second burner 114.

Preferably, the third burner 116 is located at the second end 102b of the drying drum 102.

According to an example embodiment, illustrated in FIG. 7, the second and third burners 114, 116 are arranged symmetrically relative to a vertical plane, with reference to the drawing, passing through the axis R102 to obtain a flow F15 which is as uniform as possible in the second drying chamber 112.

Generally speaking, the second and third burners 114, 116 are located preferably so as not to interact with the material present in the drum 102.

According to preferred embodiments not illustrated, the second and the third burner 114, 116 are located on a plane inclined relative to the vertical plane.

According to preferred embodiments not illustrated, the second and the third burner 114, 116 are located asymmetrically in the drying drum 102. The second and the third burner 114, 116, are located in the drier 101 as a function of the space available for the installation.

The dryer 101 comprises a ventilation system for inserting air inside the dryer 101.

The drier 101 is preferably kept under negative pressure, in a known manner, by means of the filter 22.

The ventilation system comprises a fan, schematically represented as a block 130 in FIG. 5, for generating the flow F30.

According to the preferred embodiment illustrated, the flow F30 is between 2000 m3/h and 6000 m3/h.

The drier 101 comprises a system, of substantially known type and labelled 118, for evacuating fumes. The flows F15 and F9 of combustion gas combine in the chambers 106 and 107 and reach the evacuation system 118.

As illustrated, the conduit 110 for supplying the first burner 108 passes through the second combustion chamber 113 and the second drying chamber 112.

The drier 101 comprises a tubular protection 119 for the feed duct 110. Preferably, the tubular protection 119 is coaxial with the drying drum 102.

According to the embodiment illustrated, the tubular protection 119 is fixed, for example by arms 120, to the drying drum 102 and rotates with it.

The tubular protection 119 is inserted in the second combustion chamber 113 and in the second drying chamber 112 passing through them.

The feed duct 110 is inserted in the tubular protection 119 passing through it.

The tubular protection 119 protects the supply conduit 110 both from the second and third flames 115, 117 in the second combustion chamber 113 and from the mixture of virgin and RAP materials, which are movable inside the drying drum 102, in the second drying chamber 112 and in the second combustion chamber 113.

The above-mentioned system 105 for supplying the materials is described in more detail below only with regard to the part relating to the second drying chamber 112 and the second combustion chamber 113 that is to say, the part downstream of the supply device 111.

With reference in particular to FIGS. 4 and 6, it should be noted that the supply system 105 comprises a comb-type blade unit 121, fixed to an inner surface of the drying drum 102 at the second drying chamber 112.

The blade unit 121 causes the mixture to rain through the flow F15 corresponding to a heat exchange of fumes/materials thanks to which the temperature of the mixture is raised before being unloaded.

The supply system 105 comprises a plurality of tiles 122 for protecting the base of the drier 101 at the second combustion chamber 113.

The tiles 122 are configured to prevent the lifting of the material which therefore advances sliding on the bottom of the drying drum 102, with reference, for example, to FIG. 4.

In this way, the mixture of inert lithic material and recycled bituminous material avoids the second flame 115 and/or the third flame 117 so that the recycled bituminous material does not release pollutant emissions due to the combustion of the bitumen.

The preferred dryer described allows, compared with other dryers, with the same temperature of the mixture and that reached by the virgin material, the addition of a greater quantity of recycled bituminous material to the virgin lithic material since the mixture, which undergoes a greater lowering of the temperature, is subsequently heated in the second drying chamber before the unloading.

The Applicant has observed that with the preferred drier it is possible to reach percentages of RAP of up to 60% by weight of the mixture.

In the same way, it is possible to heat less the virgin materials due to the subsequent heating of the mixture.

The second and the third burners have reduced power in such a way as to contain the increase in the temperature of the RAP so as not to generate pollutant compounds but sufficient to bring the temperature of the mixture to the desired values at the outlet, necessary for the subsequent processing.

Advantageously, the gases generated in the second combustion chamber, are conveyed into the first combustion chamber having the characteristics for thermally processing any pollutant compounds, as described, for example, in patent document EP3221517. The Applicant has observed that with the dryer 101 described, it is possible to contain pollutant emissions below 50 mg/Nm3 VOC.

1. An industrial plant for the production of bituminous macadams comprising
a drier comprising
a drying drum rotating about its own main axis of extension;
a loading head at a first end of the drying drum, for introducing a virgin inert lithic material into the drying drum;
an unloading head at a second end of the drying drum;
a supplying device between said loading head and said unloading head for introducing a recycled bituminous material into the drying drum,
at least one burner for generating a drying flow in the drying drum;
a system for feeding the virgin inert lithic material and the recycled bituminous material according to a first feed direction from said loading head and from said supplying device to said unloading head; a by-product comprising the virgin inert lithic material and/or the recycled bituminous material coming out from the unloading head of the dryer; said industrial plant comprising
a mixer downstream of the dryer according to a second feed direction of the by-product coming out from said dryer
said industrial plant being characterised in that the mixer is positioned lower than the dryer and in that it comprises
a first supply line between said unloading head and said mixer for supplying said by-product to said mixer, a second supply line between said unloading head and said mixer for supplying said by-product to said mixer, a diverter between said unloading head and said first and second supply lines adjustable between a first operating configuration wherein said unloading head is in communication with said first supply line and a second operating configuration wherein said unloading head is in communication with said second supply line, said first supply line has a first inlet in communication with said diverter and a first outlet at said mixer and said second supply line comprises a second inlet in communication with said diverter and a second outlet at said mixer.

2. The industrial plant according to claim 1, wherein said first supply line comprises a sieving unit forming said first inlet.

3. The industrial plant according to claim 2, wherein said sieving unit comprises a sieve.

4. The industrial plant according to claim 3, wherein the sieving unit comprises a transit channel for said by-product and a by-pass system for excluding the sieve from the first supply line.

5. The industrial plant according to claim 2, wherein said first supply line comprises at least one hopper (14, 15) downstream of the sieving unit.

6. The industrial plant according to claim 1, wherein said first supply line comprises a first weighing machine defining said first outlet.

7. The industrial plant according to claim 1, wherein said second supply line comprises at least one heated hopper.

8. The industrial plant according to claim 7, wherein said heated hopper defines said second inlet.

9. The industrial plant according to claim 1, wherein said second supply line comprises a second weighing machine defining said second outlet.

10. The industrial plant according to claim 1, wherein said unloading head comprises said diverter.

11. The industrial plant according to claim 1, wherein said diverter comprises a first conduit oriented towards the first supply line and a second conduit oriented towards the second supply line.

12. The industrial plant according to claim 11, wherein the first supply line comprises said first conduit and the second supply line comprises said second conduit.

13. The industrial plant according to claim 1, wherein said first supply line comprises a first weighing machine defining said first outlet and said second supply line comprises a second weighing machine defining said second outlet, said second weighing machine being of the type for weight for conglomerates with a high RAP content.

14. The industrial plant according to claim 1, wherein said first supply line and said second supply line extend under said drier.
